(19) United States
(12) Patent Application Publication
(10) Pub. No.: US 2007/0057925 A1
(43) Pub. Date: Mar. 15, 2007

(54) Touch display module and power saving method thereof

(75) Inventor: Haw-Yun Hung, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/517,318

(22) Filed: Sep. 8, 2006

(30) Foreign Application Priority Data
Sep. 9, 2005 (TW) 94131214

(51) Int. Cl. G09G 5/00

(52) U.S. Cl. 345/173

(57) ABSTRACT

A touch display module for use in an electronic device includes a touch screen for receiving a touch signal, a detection unit for detecting a state of the touch display module, a logic unit for generating a control signal depending on the touch signal, the state and a determining condition, and a light source capable of illuminating the touch screen according to the control signal.

### FIELD OF THE INVENTION

The invention relates to a touch display module and a power saving method thereof, and more particularly to a touch display module for use in an electronic device and a power saving method thereof. The touch display module includes a touch screen, which is sensitive to a touch signal and detects a state of the touch display module for turning on or turning off a backlight for the touch screen.

### BACKGROUND OF THE INVENTION

Nowadays, the mobile communication devices people daily use have more and more functions to complement the improved living standard of the people. It is therefore in the main trend to provide a touch display module for facilitating or enhancing the inputting of information in the mobile communication device.

FIG. 1 shows a block diagram illustrating a prior art touch display module that includes a touch screen 11, a light source 12, a converting unit 13 and a processing unit 14. The touch screen 11 is sensitive to a touch signal and transmits the touch signal to the converting unit 13 for activating the light source 12 in order to illuminate the touch screen 11. The converting unit 13 is capable of converting the touch signal into a digital signal that is transmitted to the processing unit 14 for being processed. Later, the processing unit 14 outputs a command to perform a specific function.

It is noted that the touch screen 11 may be accidentally touched during the talking operation, such as the mobile phone approaches the user's ear during talking. The light source 12 is activated unexpectedly and results in power waste.

### SUMMARY OF THE INVENTION

Therefore, it is the object of the present invention to provide a power saving method and a touch display module which includes a detection unit that cooperates with a logic unit to detect a touch signal for turning on or off the backlight of the touch screen, thereby achieving the power saving purpose.

According to the present invention, a touch display module for use in an electronic device is provided. The touch display module accordingly includes a touch screen for receiving a touch signal, a detection unit for detecting a state of the touch display module, a logic unit for generating a control signal depending on the touch signal, the state and a determining condition, and a light source capable of illuminating the touch screen according to the control signal.

In another aspect of the present invention, a power saving method is provided for use in an electronic device having a touch display module. The power saving method includes (a) a touch screen of the touch display module receiving a touch signal; (b) detecting a state of the touch display module; (c) generating a control signal by a logic unit depending on the touch signal, the state, and a determining condition; and (d) the control signal controlling a light source capable of illuminating the touch screen.

### BRIEF DESCRIPTION OF THE DRAWING

Other features and advantages of this invention will become more apparent in the following detailed description of the preferred embodiments of this invention, with reference to the accompanying drawings, in which:

FIG. 1 is a block diagram illustrating a prior art touch display module;

FIG. 2 is a block diagram illustrating a first embodiment of a touch display module of the present invention;

FIG. 3 is a block diagram illustrating a second embodiment of the touch display module of the present invention; and

FIG. 4 illustrates a flow chart illustrating a power saving method used by the touch display module of the present invention.

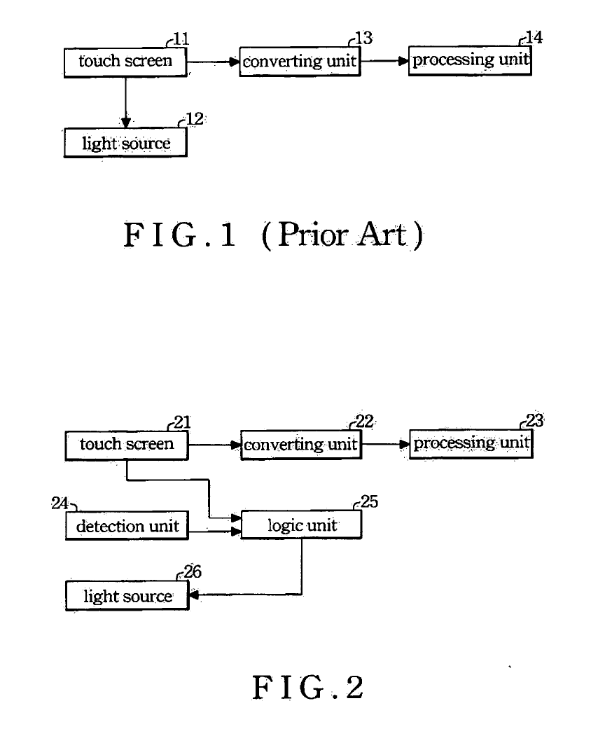

### DETAILED DESCCRIPTIONS OF THE PREFERRED EMBODIMENTS

FIG. 2 shows a block diagram illustrating the first embodiment of the touch display module of the present invention. The first embodiment accordingly includes a touch screen 21, a converting unit 22, a processing unit 23, a detection unit 24, a logic unit 25 and a light source 26. The touch screen 21 is sensitive to a touch signal and is used for displaying an image. The touch screen 21 is used for receiving the touch signal and transmits the touch signal to the converting unit 22. The converting unit 22 converts the touch signal into a digital signal that is transmitted to the processing unit 23. Then the processing unit 23 inputs a command corresponding to the digital signal to perform a specific function. In this first embodiment, the detection unit 24 includes the light sensor for detecting an ambient light condition for determining a state of the touch display module. The determining condition then is stored within the logic unit 25 for generating a control signal. Under this condition, when the state represents insufficient ambient light condition of the touch screen, the control signal restrains the light source from illuminating the touch screen 21. When the touch screen does not receive the touch signal and the state represents sufficient ambient light condition of the touch screen, the control signal restrains the light source from illuminating the touch screen 21, thereby saving the electrical power source.

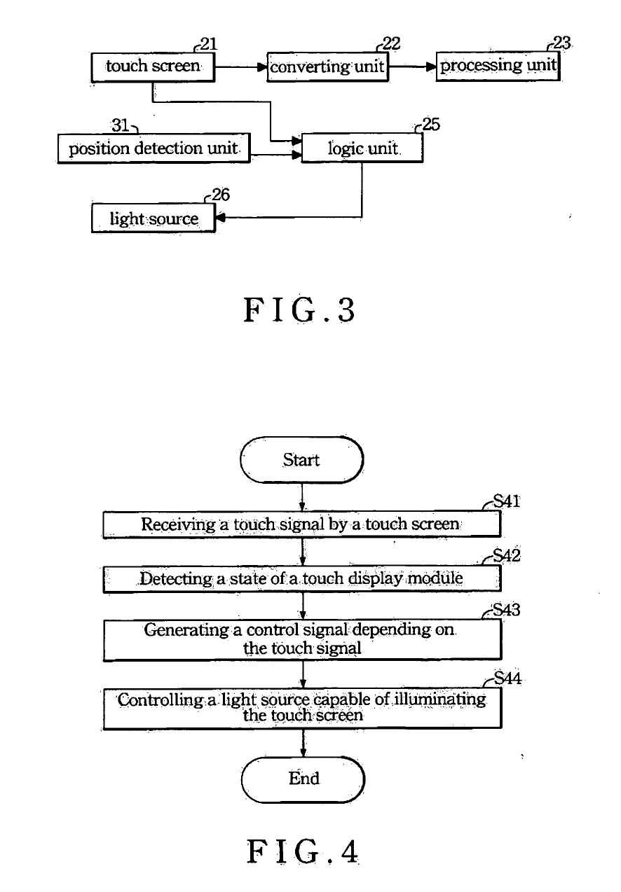

FIG. 3 shows a block diagram illustrating the second embodiment of the touch display module of the present invention. The second embodiment accordingly includes a touch screen 21, a converting unit 22, a processing unit 23, a logic unit 25, a light source 26 and a position detection unit 31. The touch screen 21 is used for receiving a touch signal and transmits the touch signal to the converting unit 22. The touch signal is also transmitted to the logic unit 25. The position detection unit 31 is used for detecting a position of the touch display module. In case the touch display module is in a substantially horizontal position and the touch screen does not receive the touch signal, the logic unit 25 generates a control signal, which restrains the light source from illuminating the touch screen 21. In case, the touch display module is held in a non-horizontal position, the logic unit 25 generates a control signal which restrains the light source from illuminating the touch screen 21, thereby saving power consumed by the light source.

FIG. 4 shows a flow chart illustrating the power saving method utilized by the touch display module of the present invention. The touch display module generally includes a touch screen, a detection unit, a logic unit and a light source. The power saving method accordingly includes (S41) a touch screen receiving touch signal; (S42) detecting a state of the touch display module; (S43) generating a control signal depending on the touch signal, the state and a determining condition; and (S44) the control signal controlling a light source capable of illuminating the touch screen.

In the aforementioned paragraph, the detection unit includes the light sensor, and the state is represented by the external light. In case, the position detection unit is used for detecting the substantial horizontal position of the touch display module, which defines the state. The logic unit will transmit the control signal to drive the light source to illuminate the touch screen when the touch screen receives the touch signal. In contrast to the aforementioned facts, when the touch screen does not receive the touch signal, the control signal restrains the light source from illuminating the touch screen in order to save the power consumed by the source.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A touch display module for an electronic device, comprising:
a touch screen sensitive to a touch signal and for displaying an image;
a detection unit for detecting a state of the touch display module;
a logic unit for generating a control signal depending on the touch signal, the state, and a determining condition; and
a light source capable of illuminating said touch screen according to said control signal.

2. The touch display module according to claim 1, further comprising a converting unit for converting the touch signal into a digital signal.

3. The touch display module according to claim 2, further comprising a processing unit which processes said digital signal to output a command for generating said control signal.

4. The touch display module according to claim 2, wherein said digital signal relates to a position on the touch screen controlled by the touch signal.

5. The touch display module according to claim 1, wherein said detection unit comprises a light sensor.

6. The touch display module according to claim 5, wherein said light sensor is capable of detecting an ambient light condition for determining the state of the touch display module, the state comprising an insufficient ambient light condition or a sufficient ambient light condition.

7. The touch display module according to claim 6, wherein the determining condition stipulates that when the state is the insufficient ambient light condition of said touch screen, the control signal restrains the light source from illuminating the touch screen.

8. The touch display module according to claim 6, wherein the determining condition stipulates that when the touch signal is not received by the touch screen and the state is the sufficient ambient light condition of said touch screen, the control signal restrains the light source from illuminating the touch screen.

9. The touch display module according to claim 6, wherein the determining condition stipulates that when the touch signal is received by the touch screen and the state is the sufficient ambient light condition of said touch screen, the control signal drives the light source to illuminate the touch screen.

10. The touch display module according to claim 1, wherein the state of the touch display module concerns a position of the touch display module.

11. The touch display module according to claim 10, wherein said detection unit comprises a position detection unit for detecting a position of the touch display module.

12. The touch display module according to claim 11, wherein the determining condition stipulates that when the position detection unit detects that the touch display module is held in a non-horizontal position, the control signal restrains the light source from illuminating the touch screen.

13. The touch display module according to claim 11, wherein the determining condition stipulates that when the touch signal is not received by the touch screen and the position detection unit detects that the touch display module is in a substantially horizontal position, the control signal restrains the light source from illuminating the touch screen.

14. The touch display module according to claim 11, wherein the determining condition stipulates that when the touch signal is received by the touch screen and the position detection unit detects that the touch display module is in a substantially horizontal position, the control signal drives the light source to illuminate the touch screen.

15. The touch display module according to claim 1, wherein the light source is part of a backlight.

16. The touch display module according to claim 1, wherein said determining condition is stored within said logic unit in advance for determining the control signal.

17. A power saving method for an electronic device having a touch display module, comprising:
(a) a touch screen of the touch display module receiving a touch signal;
(b) detecting a state of the touch display module;
(c) generating a control signal depending on the touch signal, the state, and a determining condition; and
(d) the control signal controlling a light source capable of illuminating the touch screen.

18. The power saving method according to claim 17, wherein said detecting state means detecting an ambient light condition of the touch display module.

19. The power saving method according to claim 18, wherein the determining condition stipulates that when the state represents an insufficient ambient light condition of said touch screen, the control signal restrains the light source from illuminating the touch screen, thereby saving power consumed by the light source.

20. The power saving method according to claim 18, wherein the determining condition stipulates that when the touch signal is not received by the touch screen and the state represents a sufficient ambient light condition of said touch screen, the control signal restrains the light source from illuminating the touch screen, thereby saving power consumed by the light source.

21. The power saving method according to claim 18, wherein the determining condition stipulates that when the touch signal is received by the touch screen and the state represents a sufficient ambient light condition of said touch screen, the control signal drives the light source to illuminate the touch screen.

22. The power saving method according to claim 17, wherein detecting the state comprises detecting a position of the touch display module.

23. The power saving method according to claim 22, wherein the determining condition stipulates that when it is detected that the touch display module is held in a non-horizontal position, the control signal restrains the light source from illuminating the touch screen, thereby saving power consumed by the light source.

24. The power saving method according to claim 22, wherein the determining condition stipulates that when the touch signal is not received by the touch screen and it is detected that the touch display module is in a substantially horizontal position, the control signal restrains the light source from illuminating the touch screen, thereby saving power consumed by the light source.

25. The power saving method according to claim 22, wherein the determining condition stipulates that when the touch signal is received by the touch screen and is detected that the touch display module is in a substantially horizontal position, the control signal drives the light source to illuminate the touch screen.

26. The power saving method according to claim 17, wherein the light source is part of a backlight.
